(19) United States
(12) Patent Application Publication
(10) Pub. No.: US 2026/0011503 A1
(43) Pub. Date: Jan. 8, 2026

(54) MULTILAYER CERAMIC ELECTRONIC COMPONENT

(71) Applicant: Murata Manufacturing Co., Ltd., Nagaokakyo-shi (JP)

(72) Inventors: Tomoki KITAGAWA, Nagaokakyo-shi (JP); Tatsunori YASUDA, Nagaokakyo-shi (JP)

(21) Appl. No.: 19/325,826

(22) Filed: Sep. 11, 2025

Related U.S. Application Data
(63) Continuation of application No. PCT/JP2024/010990, filed on Mar. 21, 2024.

(30) Foreign Application Priority Data
Mar. 30, 2023 (JP) 2023-056331

(51) Int. Cl. H01G 4/30; H01G 4/232

(52) U.S. Cl. CPC H01G 4/30; H01G 4/232

(57) ABSTRACT

A multilayer ceramic capacitor includes a stack including an inner layer portion including dielectric layers and inner electrode layers alternately stacked, two main surfaces opposing each other in a stacking direction, two end surfaces opposing each other in a length direction, and two side surfaces opposing each other in a width direction, two external electrodes connected to the inner electrode layers on each of the two end surfaces, and covering the end surfaces and portions of the two main surfaces extending therefrom and opposing each other, and two spacers on one of the two main surfaces of the stack with the external electrodes interposed therebetween. The spacers each include first, second, and third regions that are continuous in the width direction, and of which two adjacent regions have different shapes.

### CROSS REFERENCE TO RELATED APPLICATIONS

This application claims the benefit of priority to Japanese Patent Application No. 2023-056331 filed on Mar. 30, 2023 and is a Continuation Application of PCT Application No. PCT/JP2024/010990 filed on Mar. 21, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors.

### 2. Description of the Related Art

Multilayer ceramic capacitors include an inner layer portion in which dielectric layers and internal electrodes are alternately laminated. Then, dielectric layers defining and functioning as outer layer portions are provided at the top and bottom of the inner layer portion to form a multilayer body having a rectangular parallelepiped shape, and external electrodes are provided on both end surfaces in the longitudinal direction of the multilayer body to form a capacitor main body.

Furthermore, in order to suppress the occurrence of “acoustic noise”, multilayer ceramic capacitors each provided with spacers that each cover a portion of a corresponding one of the external electrodes on a side of the capacitor main body to be mounted on a substrate are known (see, for example, Japanese Unexamined Patent Application, Publication No. 2015-216337).

However, depending on the shape of the spacers, it may be difficult to mount the multilayer ceramic capacitor on a circuit board, or when solder that is heated and melted during mounting spreads along the surface of the spacers and wets up high in the dimension in the height direction of the multilayer ceramic capacitor, the stretching vibration of the inner layer portion propagates to the circuit board, which may make it difficult to suppress the occurrence of acoustic noise.

Therefore, the development of multilayer ceramic capacitors that are each able to be reliably mounted on a circuit board and suppress the occurrence of acoustic noise has been demanded.

### SUMMARY OF THE INVENTION

Example embodiments of the present invention provide multilayer ceramic capacitors that are each able to be reliably mounted on a circuit board and reduce or prevent acoustic noise.

The inventors of example embodiments of the present invention have discovered that, by arranging each spacer provided on one main surface of a multilayer body with an external electrode interposed therebetween include three regions continuous in the width direction, namely a first region, a second region, and a third region, and by configuring two adjacent regions to have different shapes from each other, it is possible to ensure reliable mounting on a circuit board, prevent heated and melted solder from spreading along the surface of each spacer and spreading high in a direction perpendicular or substantially perpendicular to the mounting surface of the capacitor main body, and reduce or prevent the occurrence of acoustic noise, thereby arriving at completion of the present invention.

An example embodiment of the present invention provides a multilayer ceramic electronic component which includes a multilayer body including two main surfaces opposed to each other in a lamination direction, two end surfaces opposed to each other in a length direction intersecting the lamination direction, and two lateral surfaces opposed to each other in a width direction intersecting the lamination direction and the length direction, two external electrodes each covering the corresponding one of the two end surfaces and portions of the two main surfaces extending from the corresponding one of the two end surfaces, and two spacers each on one of the two main surfaces of the multilayer body with a corresponding one of the two external electrodes interposed between with the one of the two main surfaces, in which each of the two spacers includes a first region, a second region, and a third region which are continuous in the width direction, and two adjacent regions among the first, second, and third regions have different shapes.

According to example embodiments of the present invention, multilayer ceramic capacitors that are each able to be reliably mounted on a circuit board and reduce or prevent acoustic noise are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram showing the external appearance of a multilayer ceramic capacitor 1 according to an example embodiment of the present invention.

FIG. 2 is a cross-sectional view of the multilayer ceramic capacitor 1 taken along the line II-II shown in FIG. 1.

FIG. 3 is a cross-sectional view of the multilayer ceramic capacitor 1 taken along the line III-III shown in FIG. 1.

FIGS. 4A to 4C are plan views of spacers having various shapes as viewed from the lamination direction.

FIG. 5 is an enlarged cross-sectional view of one of the spacers 4 shown in FIG. 2.

FIG. 6 is a flowchart showing a manufacturing method of the multilayer ceramic capacitor 1 according to an example embodiment of the present invention.

FIGS. 7A to 7D are diagrams explaining a multilayer body manufacturing step S1, a base electrode layer forming step S2, and a first plated layer forming step S3.

FIG. 8 is a cross-sectional view showing the multilayer ceramic capacitor 1 without a second plated layer 32.

FIG. 9 is a cross-sectional view of the multilayer ceramic capacitor 1 provided with a reinforcing material 50.

FIGS. 10A to 10C are diagrams explaining a reinforcing material placement step S6.

### DETAILED DESCRIPTION OF THE EXAMPLE EMBODIMENTS

In the following, multilayer ceramic capacitors 1 will be described as example embodiments of multilayer ceramic electronic components of the present invention, but the present invention is not limited thereto. Also, the drawings may be schematically simplified to explain the content of the present invention, and the ratio of dimensions of the components or between components shown may not match the ratio of their dimensions described in the specification. Also, components described in the specification may be omitted in the drawings, or the number of components may be reduced in the drawings.

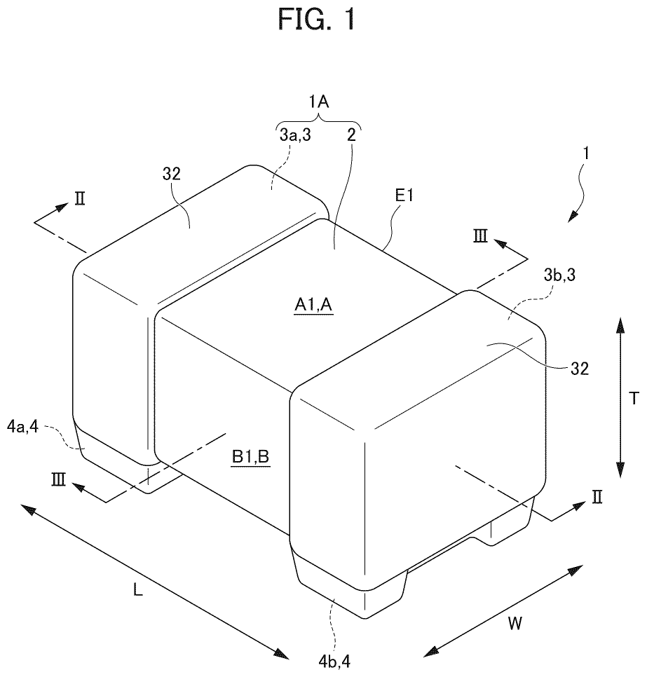

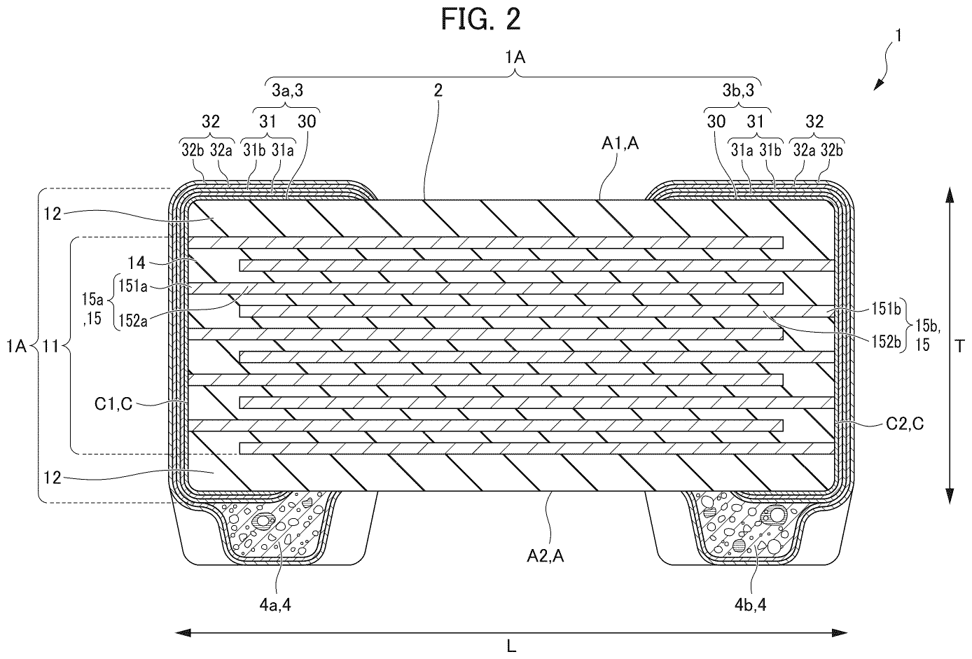

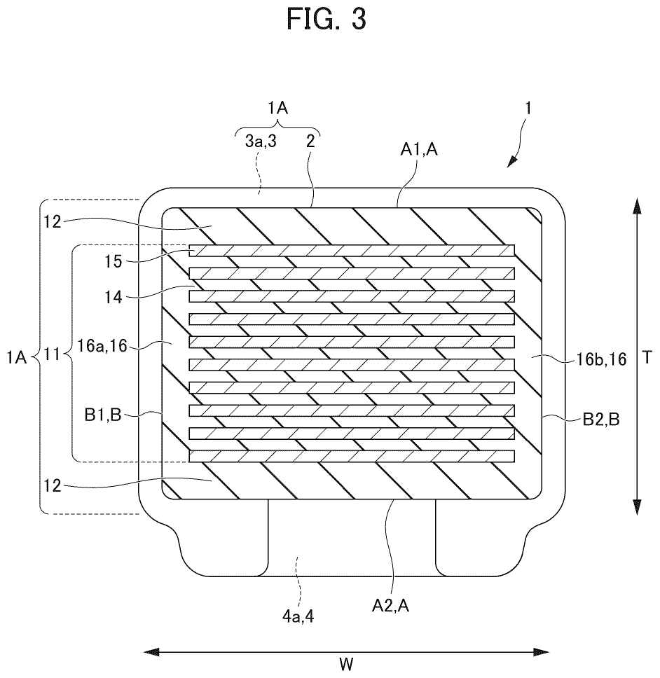

FIG. 1 is a schematic perspective view of a multilayer ceramic capacitor 1 according to an example embodiment of the present invention. FIG. 2 is a cross-sectional view taken along the line II-II in FIG. 1 of the multilayer ceramic capacitor 1 according to an example embodiment. FIG. 3 is a cross-sectional view taken along the line III-III in FIG. 1 of the multilayer ceramic capacitor 1 according to an example embodiment.

The multilayer ceramic capacitor 1 has a rectangular or substantially rectangular parallelepiped shape, and includes a capacitor main body 1A including a multilayer body 2 and a pair of external electrodes 3 provided at both ends of the multilayer body 2, and at least one spacer 4 attached to the capacitor main body 1A. The multilayer body 2 includes an inner layer portion 11 including a plurality of sets of dielectric layers 14 and internal electrode layers 15 laminated together.

In the following description, as terms representing the orientation of the multilayer ceramic capacitor 1, the direction in which the pair of external electrodes 3 are provided in the multilayer ceramic capacitor 1 is defined as the length direction L. The direction in which the dielectric layers 14 and the internal electrode layers 15 are laminated is defined as the lamination direction T. The direction intersecting both the length direction L and the lamination direction T is defined as the width direction W. In the example embodiments, the width direction W is orthogonal or substantially orthogonal to both of the length direction L and the lamination direction T.

### Outer Surface of Multilayer Body 2

Among the six outer surfaces of the multilayer body 2, a pair of outer surfaces opposed to each other in the lamination direction T is defined as a first main surface A1 and a second main surface A2, a pair of outer surfaces opposed to each other in the width direction W is defined as a first lateral surface B1 and a second lateral surface B2, and a pair of outer surfaces opposed to each other in the length direction L is defined as a first end surface C1 and a second end surface C2. When there is no need to particularly distinguish between the first main surface A1 and the second main surface A2, they are collectively referred to as main surfaces A, when there is no need to particularly distinguish between the first lateral surface B1 and the second lateral surface B2, they are collectively referred to as lateral surfaces B, and when there is no need to particularly distinguish between the first end surface C1 and the second end surface C2, they are collectively referred to as end surfaces C.

The multilayer body 2 preferably has rounded ridge portions E1 including corner portions. The ridge portions E1 are portions where two surfaces of the multilayer body 2 intersect, i.e., the main surface A and the lateral surface B, the main surface A and the end surface C, or the lateral surface B and the end surface C intersect.

### Multilayer Body 2

The multilayer body 2 includes an inner layer portion 11 that generates capacitance, outer layer portions 12 that sandwich the inner layer portion 11 from the lamination direction T, and side gap portions 16 that sandwich the inner layer portion 11 and the outer layer portions 12 from the width direction W.

### Inner Layer Portion 11

The inner layer portion 11 includes a plurality of sets of dielectric layers 14 and internal electrode layers 15 alternately laminated along the lamination direction T.

### Dielectric Layer 14

The dielectric layers 14 are made of a ceramic material. As the ceramic material, for example, a dielectric ceramic with BaTiO₃ as a main component is used.

### Internal Electrode Layer 15

The internal electrode layers 15 include a plurality of first internal electrode layers 15a and a plurality of second internal electrode layers 15b. The first internal electrode layers 15a and the second internal electrode layers 15b are alternately provided. The first internal electrode layers 15a each include a first counter portion 152a opposed to a corresponding one of the second internal electrode layers 15b, and a first extension portion 151a extending from the first counter portion 152a toward the first end surface C1. The end portion of the first extension portion 151a is exposed at the first end surface C1 and is electrically connected to the first external electrode 3a described later. The second internal electrode layers 15b each include a second counter portion 152b opposed to a corresponding one of the first internal electrode layers 15a, and a second extension portion 151b extending from the second counter portion 152b toward the second end surface C2. The end portion of the second extension portion 151b is electrically connected to the second external electrode 3b described later. Electric charge is accumulated in the first counter portion 152a of each of the first internal electrode layers 15a and the second counter portion 152b of each of the second internal electrode layers 15b.

The internal electrode layers 15 are preferably made of a metal material such as, for example, nickel (Ni), copper (Cu), silver (Ag), palladium (Pd), silver-palladium (Ag—Pd) alloy, gold (Au), etc.

### Outer Layer Portion 12

The outer layer portions 12 can each be made of the same material as the dielectric layers 14 of the inner layer portion 11.

### Side Gap Portion 16

The side gap portions 16 sandwich the inner layer portion 11 and the outer layer portions 12 from the width direction W. The side gap portions 16 include a first side gap portion 16a that defines and functions as the first lateral surface B1 of the multilayer ceramic capacitor 1, and a second side gap portion 16b that defines and functions as the second lateral surface B2 of the multilayer ceramic capacitor 1. The side gap portions 16 can be made of the same material as the dielectric layer 14.

### External Electrode 3

The external electrodes 3 include a first external electrode 3a provided on the first end surface C1, and a second external electrode 3b provided on the second end surface C2. The external electrodes 3 cover not only the end surface C, but also portions of the main surface A and portions of the lateral surface B extending from the end surface C.

As described above, the end portion of the first extension portion 151a of each of the first internal electrode layers 15a is exposed at the first end surface C1 and electrically connected to the first external electrode 3a. Furthermore, the end portion of the second extension portion 151b of each of the second internal electrode layers 15b is exposed at the second end surface C2, and electrically connected to the second external electrode 3b. This provides a configuration in which a plurality of capacitor elements are electrically connected in parallel between the first external electrode 3a and the second external electrode 3b.

The external electrodes 3 each include, for example, a base electrode layer 30 and a first plated layer 31. However, it is not necessarily required that the external electrodes 3 include such a layered configuration.

The base electrode layer 30 is formed, for example, by applying and firing an electrically conductive paste containing copper (Cu). The base electrode layer 30 may also include glass.

The first plated layer 31 includes, for example, a first nickel (Ni) plated layer 31a provided on the surface of the base electrode layer 30, and a first tin (Sn) plated layer 31b provided on the surface of the first nickel (Ni) plated layer 31a. The configuration of the first plated layer 31 is not limited thereto.

### Spacer 4

The spacers 4 include a pair of a first spacer 4a and a second spacer 4b. The first spacer 4a is provided on the second main surface A2, which is a substrate mounting surface of the capacitor main body 1A. The first spacer 4a is further provided adjacent to the end surface C1 in the length direction L. The second spacer 4b is also provided on the second main surface A2, which is a substrate mounting surface of the capacitor main body 1A. The second spacer 4b is provided adjacent to the end surface C2.

The spacers 4 are each provided on the external electrode 3 of the capacitor main body 1A and on the surface extending from a corresponding one of the external electrodes 3, of the second main surface A2 of the multilayer body where the external electrode 3 is not provided.

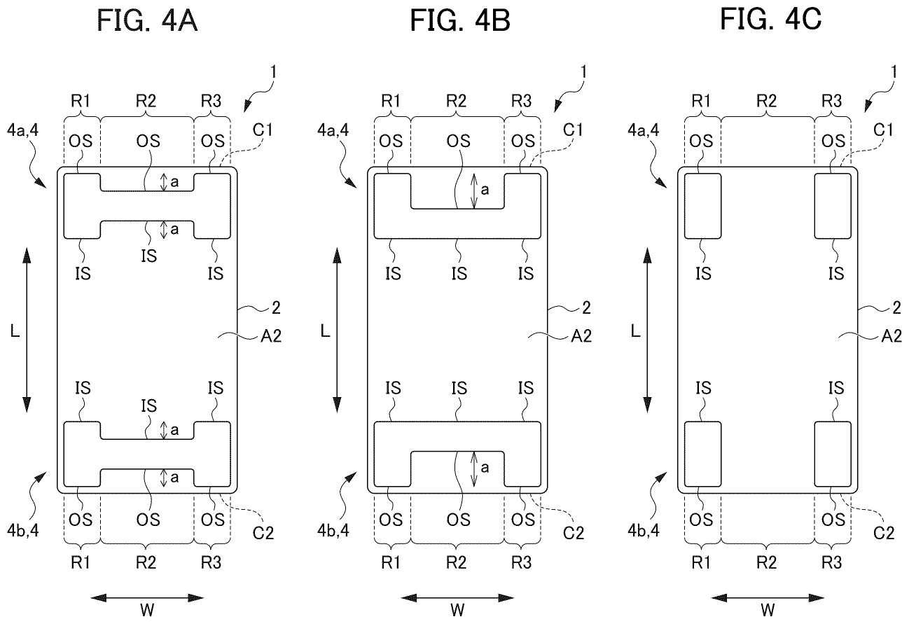

As shown in FIGS. 4A to 4C, the spacers 4 include three regions continuous in the width direction W including a first region R1, a second region R2, and a third region R3, and two adjacent regions have different shapes from each other. By providing irregularities on the surface of each of the spacers 4, it is possible to ensure reliable mounting on the circuit board and to accommodate excess molten solder in the recessed portions, thus preventing the excess solder from spreading onto the capacitor main body 1A.

When the substrate mounting surface of the capacitor main body 1A is the first lateral surface B1, the spacer 4 provides three regions continuous in the lamination direction T including the first region, the second region, and the third region.

In a plan view from the lamination direction T, the spacers 4 include three regions continuous in the width direction W including a first region R1, a second region R2, and a third region R3 each with a rectangular or substantially rectangular shape, and the dimension of the second region R2 in the length direction L may be shorter than the dimension of the other two regions in the length direction L.

In a plan view from the lamination direction T, each of the first region R1, the second region R2, and the third region R3 includes two sides opposed to each other in the length direction L, in other words, each includes an outer side OS located relatively outward on the second main surface A2 adjacent to the end surface C of the multilayer body 2, and an inner side IS opposed to the outer side OS and located relatively inward on the second main surface A2 on the opposite side from the end surface C.

As shown in each of FIGS. 4A and 4B, the outer side OS of the second region R2 is provided inward from the outer side OS of the first region R1 and the outer side OS of the third region R3, defining a recessed portion in the outward direction of each of the spacers 4. This makes it possible to accommodate excess molten solder in the recessed portion while ensuring sufficient contact area with the circuit board required for mounting, and to prevent the solder from spreading high in the direction perpendicular or substantially perpendicular to the mounting surface of the capacitor main body 1A, thus reducing or preventing the occurrence of acoustic noise caused by the propagation of stretching vibration of the inner layer portion 11 to the circuit board.

Furthermore, as shown in FIG. 4A, when the inner side IS of the second region R2 is provided outward from the inner side IS of the first region R1 and the inner side IS of the third region R3, defining a recessed portion also in the inward direction of the spacer 4, each of the spacers 4 has an H-shape in a plan view from the lamination direction T, with recessed portions provided in the outward direction adjacent to the end surface C of the multilayer body 2 and in the inward direction on the opposite side. By providing the two recessed portions in each of the spacers 4 in this manner, it is possible to accommodate excess molten solder more reliably, and thus it is possible to reduce or prevent the occurrence of acoustic noise caused by solder spreading.

The recessed portions provided in each of the spacers 4 in this manner can be defined by curved surfaces having an arc shape or a shape approximating this in a plan view from the lamination direction T. For example, when both or either one of the outer side OS and the inner side IS of the second region R2 has an arc shape with a predetermined radius of curvature in a plan view from the lamination direction T, excess molten solder flows smoothly into the recessed portions, making it possible to effectively reduce or prevent the occurrence of acoustic noise due to solder spreading.

The outer side OS of the second region R2 is located inward by, for example, a length corresponding to about 30% or more of the length of the region having the longer length in the length direction L among the first region R1 and the third region R3, from the outer side OS located more outward among the outer sides OS of the first region R1 and the third region R3. The inner side IS of the second region R2 is located outward by, for example, a length corresponding to about 30% or more of the length of the region having the longer length in the length direction L among the first region R1 and the third region R3, from the inner side IS located more inward among the inner sides IS of the first region R1 and the third region R3.

The first region R1 and the third region R3 are normally regions with the same or substantially the same shape that are provided adjacent to each other with the second region sandwiched therebetween in the width direction W. The length of the first region R1 in the length direction L and the length of the third region R3 in the length direction L are the same or substantially the same, but when the length of the first region R1 in the length direction L and the length of the third region R3 in the length direction L are different from each other, the length corresponding to about 30% or more, for example, can be calculated based on the longer length. In addition, when the outer sides OS of the first region R1 and the third region R3 are not on a straight line in the width direction W, the position of the outer side OS of the second region can be determined based on the outer side OS that is located more outward. Similarly, when the inner sides IS of the first region R1 and the third region R3 are not on a straight line in the width direction W, the position of the inner side IS of the second region can be determined based on the inner side IS that is located more inward.

The length of the second region R2 in the width direction W is, for example, preferably about ¼ or more and about ⅔ or less of the length of the spacer 4 in the width direction W. When the length of the second region R2 in the width direction W is less than about ¼ of the length of the spacer 4 in the width direction W, the opening of the recessed portion in the spacer 4 becomes small, making it difficult to smoothly accommodate molten solder. In addition, when the length of the second region R2 in the width direction W is longer than about ⅔ of the length of the spacer 4 in the width direction W, it becomes difficult to sufficiently maintain the bonding strength of the spacer 4 to the capacitor main body 1A.

The shape of each of the spacers 4 of the multilayer ceramic capacitor 1 is photographed using a microscope (BX-51) connected to a digital camera for microscopes (DP22, manufactured by Olympus) at a total magnification of about 10 times to obtain a plan view image from the lamination direction T. The length of each portion can be measured and confirmed from the photographed image.

As shown in FIG. 4C, the second region R2 may be a space formed by cutting out the middle portion of each of the spacers 4.

Each of the spacers 4 includes, as metal powder, for example, either copper (Cu) or nickel (Ni), and tin (Sn). The copper (Cu) and nickel (Ni) may be coated with silver (Ag), for example. The intermetallic compound formed by adding either copper (Cu) or nickel (Ni) and tin (Sn) is not subject to thermal deformation even during soldering when the multilayer ceramic capacitor 1 is mounted on a circuit board, and makes it possible to reliably maintain the shape of the spacer 4. In particular, for example, an intermetallic compound formed by adding tin (Sn) to an alloy of copper (Cu) and nickel (Ni) is preferable as a component for forming the spacers 4.

The metal region MP including the metal powder includes phenol resin, for example. The phenol resin coats the intermetallic compound particles and is scattered to fill the gaps between the particles. The phenol resin may not necessarily completely coat the intermetallic compound particles. In addition, by using phenol resin, the amount of gas generated during the heat treatment when forming the spacer 4 can be reduced, such that it is possible to reduce the voids P in the spacers 4. The phenol resin may be exposed on the surface of each of the spacers 4 and cover at least a portion of the surface of each of the spacers 4. By covering the surface of each of the spacers 4 with phenol resin, the smoothness of the surface of the spacer 4 is improved, and it is possible to increase the mechanical strength of the spacer 4.

Examples of the phenol resin include novolac-type phenol resins such as phenol novolac resin, phenol aralkyl resin, cresol novolac resin, tert-butylphenol novolac resin, or nonylphenol novolac resin, resol-type phenol resin, or polyoxystyrenes such as polyparaoxystyrene.

The area ratio of phenol resin in each of the spacers 4 is, for example, preferably about 18 or more and about 20% or less, and particularly preferably about 5% or more and about 15% or less, in the LT cross-section perpendicular or substantially perpendicular to the width direction W of each of the spacers 4. When it is less than about 18, the advantageous effect of the phenol resin cannot be sufficiently provided, and when it exceeds about 20%, there is a risk that the bonding strength of the spacer to the external electrode will decrease.

As a method for determining the area ratio (%) of phenol resin occupied in each of the spacers 4, for example, a spacer 4 is polished in the width direction W to any position in the width direction W, for example, to a position of about ⅙ in the width direction W, and the polished surface is magnified about 50 times with a microscope (BX-51) and photographed with a digital camera for microscopes (DP22 manufactured by Olympus). The obtained image is binarized to separate it into the metal region MP and the resin region RP, and from the respective areas of the metal region MP, metal powder MF, resin region RP, and void P, the area ratio (%) of phenol resin can be calculated by the formula: area ratio (%) of phenol resin=area of resin region RP/(area of metal region MP+area of metal powder MF+area of resin region RP+area of void P)×100.

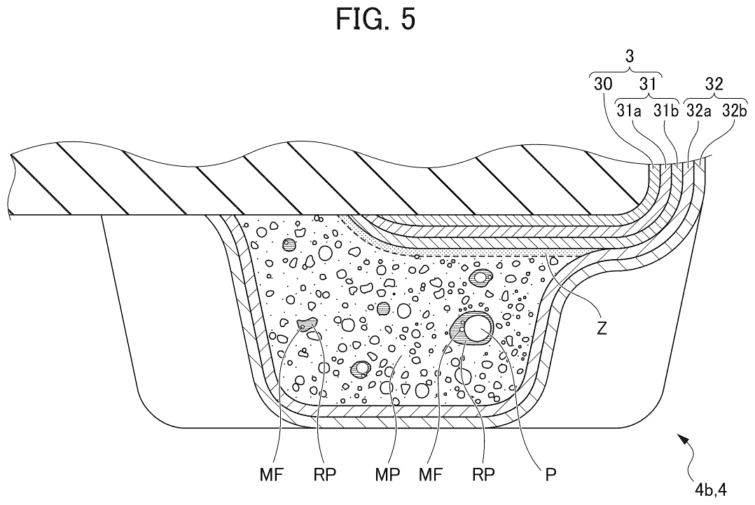

As shown in FIG. 5, the resin region RP provided by the phenol resin may include metal powder MF. The shrinkage of the phenol resin is reduced or prevented by the metal powder MF, and the shrinkage stress caused by the phenol resin can be reduced.

It is preferable that each of the spacers 4 has a void ratio of, for example, about 20% or less in a region Z within about 5 μm from the interface with a corresponding one of the external electrodes 3. This increases the bonding area of the spacer 4 that bonds with the external electrode 3, thus improving the bonding strength.

As a method for determining the void ratio (%), for example, the spacer 4 is polished in the width direction W to any position in the width direction W, for example, to a position of about ⅙ in the width direction W, and the polished surface is magnified to a total magnification of about 50 times with a microscope (BX-51) and photographed with a digital camera for microscopes (DP22 manufactured by Olympus). The obtained photographed image is binarized to separate it into the metal region MP and the void P portions, and from the respective areas of the metal region MP, metal powder MF, resin region RP, and void P, the void ratio (%) can be calculated by the formula: void ratio (%)=area of void P/(area of metal region MP+area of metal powder MF+area of resin region RP+area of void P)×100.

The maximum diameter of the voids P provided inside the spacer 4 is, for example, preferably about ½ or less of the maximum dimension in the thickness of the spacer 4 in the lamination direction T. If it exceeds about ½, cracks are likely to occur with the voids P as starting points, reducing the strength of the spacer 4.

In the above, a configuration including an intermetallic compound and phenol resin is described as an example of the material of the spacer 4, but the present invention is not limited thereto, and may include different types of metal components, or may include resins such as, for example, epoxy resin or rosin, or glass components in addition to phenol resin. Also, it may be formed without including resin.

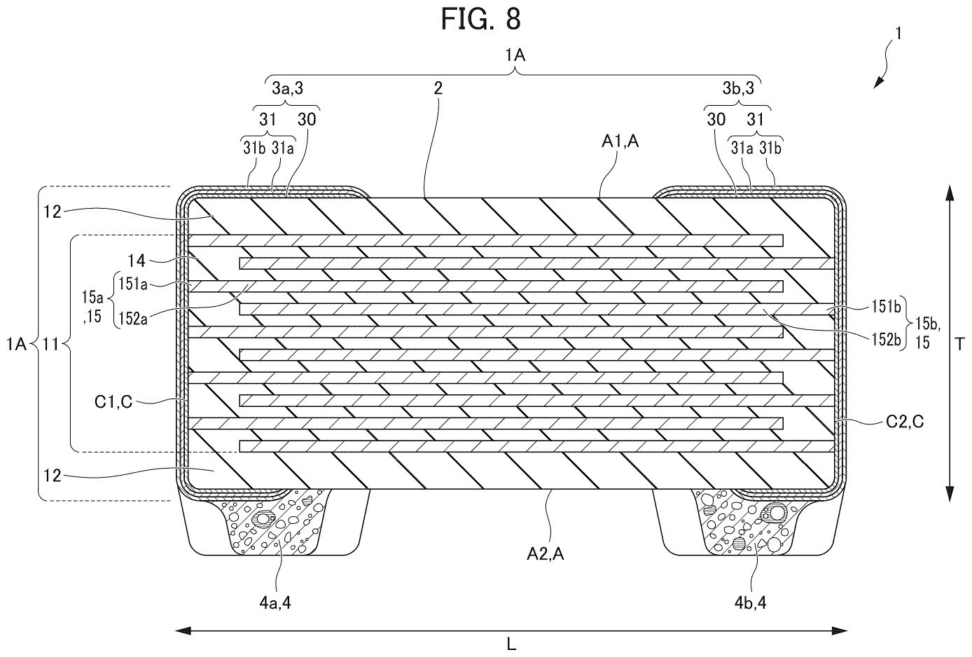

The second plated layer 32 covers the spacer 4 and the external electrode 3, but the present invention is not limited thereto, and the second plated layer 32 may not necessarily be provided on the spacer 4 and the external electrode 3 (FIG. 8). When the second plated layer 32 covers the spacer 4 and the external electrode 3, the second plated layer 32 includes, for example, a second nickel (Ni) plated layer 32a and a second tin (Sn) plated layer 32b provided on the surface of the second nickel (Ni) plated layer 32a. The second plated layer 32 is provided on the outer surface of the first tin (Sn) plated layer 31b of the first plated layer 31 in portions where the spacer 4 is not provided, and is provided on the outer surface of the spacer 4 in portions where the spacer 4 is provided. The configuration of the second plated layer 32 is not limited thereto. By providing the second plated layer 32, the bonding strength between the spacer 4 and the capacitor main body 1A is improved.

In an example embodiment of the present invention, the external electrode 3 includes the base electrode layer 30 and the first plated layer 31 that covers the base electrode layer 30, and the spacer 4 is provided on the surface of the first plated layer 31. However, the first plated layer 31 is not necessarily required. For example, the spacer 4 may be provided on the surface of the base electrode layer 30, and the second plated layer 32 may cover the spacer 4 and the base electrode layer 30. By providing the second plated layer 32, the bonding strength between the spacer 4 and the base electrode layer 30 is improved, and the mechanical strength of the spacer 4 is improved by the second plated layer 32 entering the voids P exposed on the surface of the spacer 4.

A confirmation test was conducted to confirm the advantageous effects of example embodiments of the present invention on the multilayer ceramic capacitor 1.

### Confirmation Test

The specifications of the multilayer ceramic capacitor used in the confirmation test are shown.
Dimension in length direction L: about 1.6 mm
Dimension in width direction W: about 0.8 mm
Dimension in lamination direction T: about 0.8 mm
Dimension of external electrode in length direction in a plan view from lamination direction T: about 0.25 mm
Main component of internal electrode: Ni
Main component of dielectric: BaTiO₃
Main component of base electrode layer: Cu, First plated layer: Ni, Second plated layer: Sn

A first spacer was provided on the second main surface of the multilayer ceramic capacitor to be bonded to the first external electrode, and a second spacer was provided on the second main surface of the multilayer ceramic capacitor to be bonded to the second external electrode.

### Samples

Comparative Example 1 (conventional product): In a plan view from the lamination direction T, the first spacer and the second spacer each had a rectangular or substantially rectangular shape. Examples 1 to 3: In a plan view from the lamination direction T, the outer side OS of the second region R2 of each of the first spacer 4a and the second spacer 4b was located inward by a predetermined length a from the outer side OS of each of the first region R1 and the third region R3 (the first region R1 and the third region R3 had the same shape and were provided on a straight line in the width direction W), and the inner side IS of the second region R2 of each of the first spacer 4a and the second spacer 4b was located outward by a predetermined length a from the inner side IS of the each of first region R1 and the third region R3, defining an H-shape (corresponding to FIG. 4A), and the ratio of the predetermined length a to the length of the first region R1 in the length direction L ((predetermined length a)/(length of the first region R1 in the length direction L)) was about 0.12 in Example 1, about 0.23 in Example 2, and about 0.30 in Example 3. Examples 4 and 5: In a plan view from the lamination direction T, the outer side OS of the second region R2 of each of the first spacer 4a and the second spacer 4b was located inward by a predetermined length a from the outer side OS of each of the first region R1 and the third region R3 (the first region R1 and the third region R3 had the same shape and were provided on a straight line in the width direction W), defining a U-shape (corresponding to FIG. 4B), and the ratio of the predetermined length a to the length of the first region R1 in the length direction L ((predetermined length a)/(length of the first region R1 in the length direction L)) was about 0.49 in Example 4 and about 0.61 in Example 5. Example 6: The second region R2 of each of the first spacer 4a and the second spacer 4b was a space formed by cutting out the middle portion of each spacer, and the first spacer 4a and the second spacer 4b were bonded to the external electrode at four locations (corresponding to FIG. 4C).

### Evaluation Method

Each multilayer ceramic capacitor was mounted on a mounting substrate and placed in an anechoic box. Also, a sound collection microphone was provided on the multilayer ceramic electronic component to oppose the mounting substrate. Then, an alternating current having a frequency of about 3 kHz and a voltage of about 1 Vpp was applied to the multilayer ceramic capacitor, and the vibration sound of the multilayer ceramic capacitor was collected by the sound collection microphone. The collected vibration sound was inputted to an FFT (Fast Fourier Transform) analyzer via a sound level meter to analyze the sound pressure level. Regarding the sound pressure level obtained as described above, samples with a sound pressure level reduction of about 5% or more but less than about 10% compared to the conventional rectangular or substantially rectangular sample when viewed in the lamination direction were rated as Δ (triangle symbol indicating acceptable), and samples with a sound pressure level reduction of about 10% or more were rated as o (circle symbol indicating good).

### Results

The evaluation results are shown below.

TABLE 1

| | Comparative | Example | Example | Example | Example | Example | Example |
|---|---|---|---|---|---|---|---|
| | Example 1 | 1 | 2 | 3 | 4 | 5 | 6 |
| (PREDETERMINED | 0 | 0.12 | 0.23 | 0.3 | 0.49 | 0.61 | — |
| LENGTH a)/(LENGTH | | | | | | | |
| IN LENGTH DIRECTION | | | | | | | |
| L OF FIRST REGION R1) | | | | | | | |
| EVALUATION | — | Δ | Δ | ∘ | ∘ | ∘ | ∘ |

From the results of Comparative Example 1 and Examples 1 to 5, it was confirmed that when the ratio of the predetermined length a to the length in the length direction L of the first region R1 ((predetermined length a)/(length in the length direction L of the first region R1)) was about 30% or more, the advantageous effect of reducing or preventing vibration noise was excellent.

In each of Examples 1 to 3, the recessed portion provided in the outward direction of the spacer 4 and the recessed portion provided in the inward direction had the same shape, but the present invention is not limited to this, and they may have different shapes. That is, the predetermined length a for forming the outward recessed portion and the predetermined length a for forming the inward recessed portion may be different.

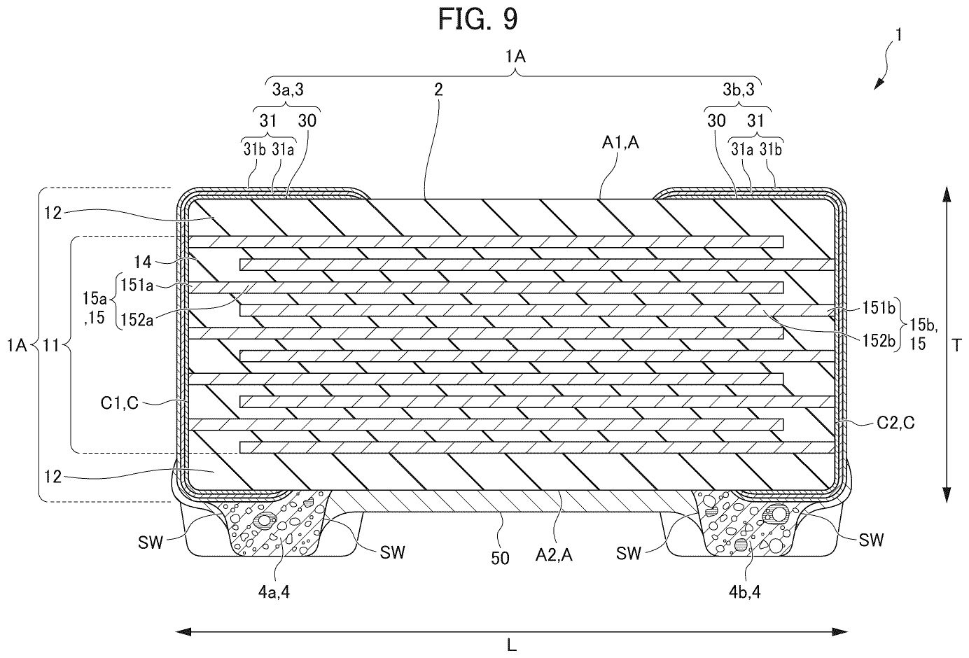

As shown in FIG. 9, between the first spacer 4a and the second spacer 4b, a reinforcing material 50 may be provided so as to cover at least a portion of at least one of the first spacer 4a or the second spacer 4b, and at least a portion of the second main surface A2 of the multilayer body 2. By providing the reinforcing material 50, it is possible to improve the bonding strength between the spacer 4 and the external electrode 3, and between the spacer 4 and the multilayer body 2.

The reinforcing material 50 may be provided continuously between the first spacer 4a and the second spacer 4b, but it is not necessary to provide the reinforcing material 50 continuously. For example, the reinforcing material 50 may be provided separately to cover a portion of the first spacer 4a and a portion of the second main surface A2 of the multilayer body 2, and another to cover a portion of the second spacer 4b and a portion of the second main surface A2 of the multilayer body 2.

The reinforcing material 50 may be made of an insulating resin, for example. The surface of the insulating resin may be covered with an insulating water-repellent treatment agent. By providing the reinforcing material, the deflection strength of the multilayer ceramic capacitor 1 is improved, and by covering with an insulating water-repellent treatment agent, moisture resistance is improved. The insulating resin may include, for example, ceramics, glass, and the like.

As the material of the reinforcing material 50, for example, epoxy resin can be used as a main component, and phenol resin can be used as a curing agent. As other curing agents, for example, acid anhydride-based, amine-based, or ester-based curing agents can be used. A curing accelerator may be further added to the epoxy resin.

The reinforcing material 50 may be provided so as to cover the lateral peripheral surface SW of the spacer 4. In this case, it is preferable that the reinforcing material 50 covers the lateral peripheral surface SW of the spacer 4 at a height of, for example, about 5% or more of the dimension of the spacer 4 in the lamination direction T while covering the second main surface A2 of the multilayer body 2. By covering with the reinforcing material 50 in this manner, mechanical strength is improved, and in particular, impact resistance when an impact is applied to the multilayer ceramic capacitor 1 can be improved.

### Method of Manufacturing Multilayer Ceramic Capacitor 1

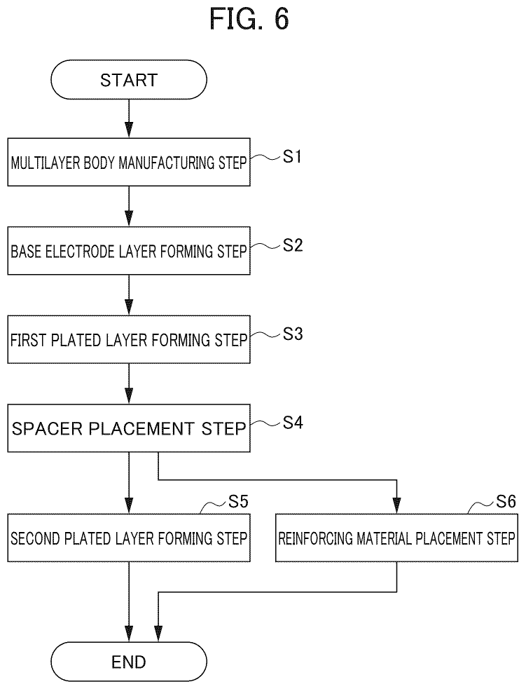

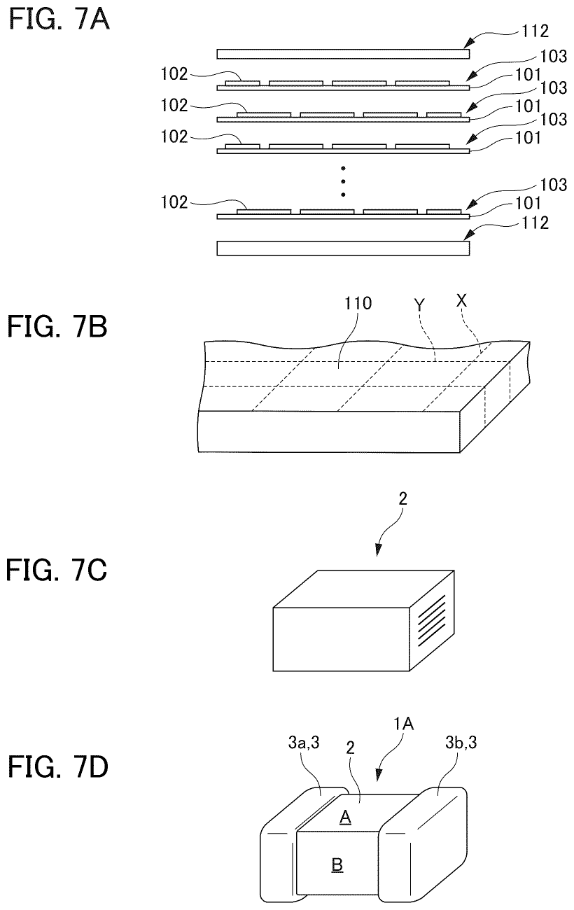

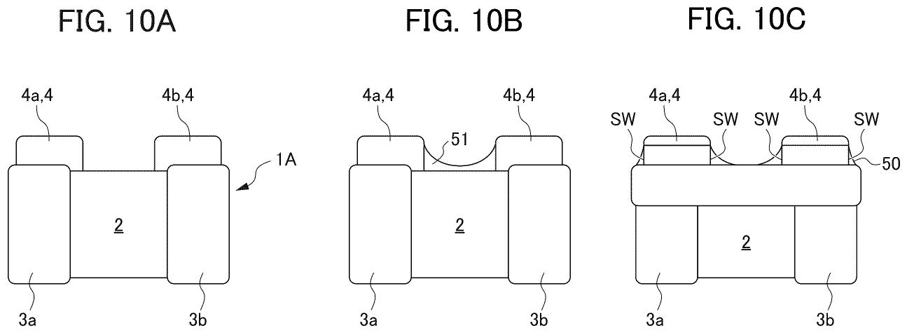

FIG. 6 is a flowchart explaining an example of a method of manufacturing the multilayer ceramic capacitor 1 according to an example embodiment of the present invention. The method of manufacturing the multilayer ceramic capacitor 1 includes a multilayer body manufacturing step S1, a base electrode layer forming step S2, a first plated layer forming step S3, a spacer placement step S4, and a second plated layer forming step S5. Further, the multilayer ceramic capacitor 1 can include the reinforcing material 50 by subjecting to a reinforcing material placement step S6 after the spacer placement step S4. FIGS. 7A to 7D are diagrams explaining the multilayer body manufacturing step S1, the base electrode layer forming step S2, and the first plated layer forming step S3. FIGS. 10A to 10C are diagrams explaining the reinforcing material placement step S6.

### Multilayer Body Manufacturing Step S1

A ceramic slurry including ceramic powder, binder, and solvent is formed into a sheet on the surface of a carrier film using, for example, a die coater, gravure coater, micro gravure coater or the like to create a multilayer ceramic green sheet 101 that defines and functions as the dielectric layer 14. Next, an electrically conductive paste is printed in a strip pattern on the multilayer ceramic green sheet 101 by, for example, screen printing, inkjet printing, gravure printing or the like, and an electrically conductive pattern 102 that defines and functions as the internal electrode layer 15 is printed on the surface of the multilayer ceramic green sheet 101 to create a material sheet 103.

Next, as shown in FIG. 7A, a plurality of material sheets 103 are stacked such that the electrically conductive patterns 102 face in the same direction and the electrically conductive patterns 102 are offset from each other by, for example, about half a pitch in the length direction between adjacent material sheets 103. Furthermore, ceramic green sheets 112 for manufacturing outer layer portions, which define and function as the outer layer portions 12, are stacked on both sides of the plurality of stacked material sheets 103.

The plurality of stacked material sheets 103 and the ceramic green sheets 112 for manufacturing outer layer portions are pressed together using, for example, a hydrostatic press or the like to create a mother block 110 as shown in FIG. 7B.

Next, the mother block 110 is cut along cutting lines X and cutting lines Y that intersect the cutting lines X as shown in FIG. 7B to manufacture a plurality of unfired multilayer bodies 2 as shown in FIG. 7C.

### Base Electrode Layer Forming Step S2

Next, the base electrode layer 30 is formed by applying and firing an electrically conductive paste including copper (Cu) to the end surfaces C of the multilayer body 2. The base electrode layer 30 extends not only on both end surfaces C of the multilayer body 2, but also to the main surfaces A and lateral surfaces B, so as to cover portions of the main surfaces A adjacent to the end surfaces C. However, the base electrode layer is not limited thereto, and may include other metals or other components, and two base electrode layers may be provided.

### First Plated Layer Forming Step S3

Next, a first nickel (Ni) plated layer 31a is formed on the outer surface of the base electrode layer 30, and a first tin (Sn) plated layer 31b is formed on the outer surface of the first nickel (Ni) plated layer 31a to manufacture the capacitor main body 1A shown in FIG. 7D.

### Spacer Placement Step S4

A spacer manufacturing paste 44 for manufacturing spacers is prepared. The spacer manufacturing paste 44 includes metals such as, for example, copper (Cu), nickel (Ni), tin (Sn), or silver (Ag), phenol resin, solvent, and additives.

Examples of the phenol resin include novolac-type phenol resins such as phenol novolac resin, phenol aralkyl resin, cresol novolac resin, tert-butylphenol novolac resin, or nonylphenol novolac resin, resol-type phenol resin, or polyoxystyrenes such as polyparaoxystyrene.

The capacitor main bodies 1A are arranged at predetermined positions on a holding substrate using suction nozzles. The spacer manufacturing paste is printed in a predetermined pattern shape on the surfaces of the capacitor main bodies 1A aligned on the holding substrate by screen printing, for example.

Next, a heat treatment is performed. When at least a portion of the metal in the paste forms an intermetallic compound and a metal region MP forms, a portion of the phenol resin is incorporated into the metal region MP while a portion thereof is discharged from the metal region MP, and the metal region MP is cured, such that a spacer 4 bonded to the capacitor main body 1A is formed.

In the above, a configuration including an intermetallic compound and phenol resin is shown as an example of the material of the spacer 4, but the present invention is not limited thereto, and may include, for example, different types of metal components, or may include resins such as epoxy resin or rosin, or glass components in addition to phenol resin. Also, it may be formed without including resin.

### Second Plated Layer Forming Step S5

Next, a second nickel (Ni) plated layer 32a may be formed on the portion where the first tin (Sn) plated layer 31b is exposed in the capacitor main body 1A and on the surface of the spacer 4, and further, a second tin (Sn) plated layer 32b may be formed on the surface of the second nickel (Ni) plated layer 32a.

### Reinforcing Material Placement Step S6

FIGS. 10A to 10C are diagrams explaining the reinforcing material placement step S6. After the spacer placement step S4, the surface of the capacitor main body 1A on which the spacers 4 are provided is cleaned with a solvent. As shown in FIG. 10A, after the cleaning is completed, the capacitor main body 1A with the spacers 4 is aligned so that the spacers 4 face upward.

Next, as shown in FIG. 10B, an insulating resin layer defining and functioning as the middle portion 51 of the reinforcing material 50 is formed between the first spacer 4a and the second spacer 4b on the capacitor main body 1A with the spacers 4, using a dispenser or squeegee printing, for example. The amount of spreading onto the lateral surface of the spacers 4 can be adjusted by changing the amount of insulating resin.

In order to allow the insulating resin to penetrate into the interface between the spacer 4 and the multilayer body 2, vacuum drawing can be performed after placing the insulating resin. The amount of penetration can be controlled by changing the time and pressure of the vacuum drawing.

Next, as shown in FIG. 10C, the insulating resin may be applied to cover the outer periphery of the capacitor main body 1A and the outer periphery of the spacers 4. Then, by heating the applied insulating resin at, for example, about 100° C. to about 200° C. for about 20 to about 80 minutes, the insulating resin can be cured to form a covered portion by the reinforcing material 50 on the outer periphery of the capacitor main body 1A and the lateral peripheral surfaces SW of the spacers 4. The multilayer ceramic capacitor 1 including the reinforcing material 50 is manufactured through the above steps.

In the above example embodiment, the reinforcing material 50 directly covers the surfaces of the spacers 4, but the present invention is not necessarily limited to such an example embodiment. For example, the second plated layer 32 may be formed on the surfaces of the spacers 4, and the reinforcing material 50 may be provided to cover the lateral peripheral surfaces SW of the spacers 4 on the surface of the second plated layer 32.

Although example embodiments of the present invention have been described above, the present invention is not limited to the example embodiments, and can be provided in various configurations without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including two main surfaces opposed to each other in a lamination direction, two end surfaces opposed to each other in a length direction intersecting the lamination direction, and two lateral surfaces opposed to each other in a width direction intersecting the lamination direction and the length direction;
two external electrodes each covering the corresponding one of the two end surfaces and portions of the two main surfaces extending from the corresponding one of the two end surfaces; and
two spacers each on one of the two main surfaces of the multilayer body, with a corresponding one of the two external electrodes interposed between with the one of the two main surfaces; wherein
each of the two spacers includes a first region, a second region, and a third region that are continuous in the width direction, and two adjacent regions among the first, second, and third regions have different shapes.

2. The multilayer ceramic electronic component according to claim 1, wherein
in a plan view from the lamination direction, the first region, the second region, and the third region of the two spacers are provided in this order in the width direction and respectively have rectangular or substantially rectangular shapes; and
a length of the second region in the length direction is shorter than lengths of the first and third regions in the length direction.

3. The multilayer ceramic electronic component according to claim 2, wherein
each of the first region, the second region, and the third region includes two sides opposed to each other in the length direction, and the two sides include an outer side located outward and adjacent to a corresponding one of the two end surfaces of the multilayer body, and an inner side located inward and opposite to the corresponding one of the two end surfaces; and
the outer side of the second region is located inward from the outer sides of the first and third regions.

4. The multilayer ceramic electronic component according to claim 3, wherein the inner side of the second region is located outward from the inner sides of the first and third regions.

5. The multilayer ceramic electronic component according to claim 4, wherein the outer side of the second region is located inward from the outer side of the first region or the third region by a length of about 30% or more of a length of the first region or the third region in the length direction, and the inner side of the second region is located outward from the inner side of the first region or the third region by a length of about 30% or more of the length of the first region or the third region in the length direction.

6. The multilayer ceramic electronic component according to claim 4, wherein the outer side of the second region is located inward from the outer side that is located more outward among the outer sides of the first region and the third region by a length of about 30% or more of a length of a region having a longer length in the length direction among the first region and the third region, and the inner side of the second region is located outward from the inner side that is located more inward among the inner sides of the first region and the third region by a length of about 30% or more of a length of a region having a longer length in the length direction among the first region and the third region.

7. The multilayer ceramic electronic component according to claim 2, wherein a length of the second region in the width direction is about ¼ or more and about ⅔ or less of a length of a corresponding one of the two spacers in the width direction.

8. The multilayer ceramic electronic component according to claim 1, wherein the second region includes a space defined by a cut out middle portion of each of the two spacers.

9. The multilayer ceramic electronic component according to claim 1, wherein each of the two spacers includes a resin.

10. The multilayer ceramic electronic component according to claim 1, wherein a reinforcing material is provided between the two spacers to cover at least a portion of the two spacers and at least a portion of the one of the two main surfaces of the multilayer body.

11. A multilayer ceramic electronic component comprising:
a multilayer body including two main surfaces opposed to each other in a lamination direction, two end surfaces opposed to each other in a length direction intersecting the lamination direction, and two lateral surfaces opposed to each other in a width direction intersecting the lamination direction and the length direction;
two external electrodes each covering the corresponding one of the two end surfaces and portions of the two lateral surfaces extending from the corresponding one of the two end surfaces; and
two spacers that are each provided on one of the two lateral surfaces of the multilayer body with a corresponding one of the two external electrodes interposed between with the one of the two lateral surfaces; wherein
each of the two spacers includes three regions including a first region, a second region, and a third region which are continuous in the lamination direction, and two adjacent regions among the three regions have different shapes.

12. The multilayer ceramic electronic component according to claim 11, wherein
in a plan view from the width direction, each of the two spacers includes a first region, a second region, and a third region each with a rectangular or substantially rectangular shape which are continuous in the lamination direction; and
a length of the second region in the length direction is shorter than lengths of the first and third regions in the length direction.

13. The multilayer ceramic electronic component according to claim 12, wherein
each of the first region, the second region, and the third region includes two sides opposed to each other in the length direction, and the two sides include an outer side located outward and adjacent to a corresponding one of the two end surfaces of the multilayer body, and an inner side located inward and opposite to the corresponding one of the two end surfaces; and
the outer side of the second region is located inward from the outer sides of the first and third regions.

14. The multilayer ceramic electronic component according to claim 13, wherein the inner side of the second region is located outward from the inner sides of the first and third regions.

15. The multilayer ceramic electronic component according to claim 14, wherein the outer side of the second region is located inward from the outer side of the first region or the third region by a length of about 30% or more of a length of the first region or the third region in the length direction, and the inner side of the second region is located outward from the inner side of the first region or the third region by a length of about 30% or more of the length of the first region or the third region in the length direction.

16. The multilayer ceramic electronic component according to claim 14, wherein the outer side of the second region is located inward from the outer side located more outward among the outer sides of the first region and the third region by a length of about 30% or more of a length of a region having a longer length in the length direction among the first region and the third region, and the inner side of the second region is located outward from the inner side located more inward among the inner sides of the first region and the third region by a length by about 30% or more of a length of a region having a longer length in the length direction among the first region and the third region.

17. The multilayer ceramic electronic component according to claim 12, wherein a length of the second region in the lamination direction is about ¼ or more and about ⅔ or less of a length of a corresponding one of the two spacers in the lamination direction.

18. The multilayer ceramic electronic component according to claim 11, wherein the second region includes a space defined by a cut out middle portion of each of the two spacers.

19. The multilayer ceramic electronic component according to claim 11, wherein each of the two spacers includes a resin.

20. The multilayer ceramic electronic component according to claim 11, wherein a reinforcing material is provided between the two spacers to cover at least a portion of the two spacers and at least a portion of the one of the two lateral surfaces of the multilayer body.
